(19) United States
(12) Patent Application Publication
(10) Pub. No.: US 2014/0355940 A1
(43) Pub. Date: Dec. 4, 2014

(54) FIBER OPTIC SPLICE PROTECTING SYSTEM AND METHOD FOR PROTECTING A FIBER OPTIC SPLICE

(71) Applicant: Emory E. Jones, III, Fincastle, VA (US)

(72) Inventor: Emory E. Jones, III, Fincastle, VA (US)

(73) Assignee: BAKER HUGHES INCORPORATED, Houston, TX (US)

(21) Appl. No.: 13/904,727

(22) Filed: May 29, 2013

(51) Int. Cl. G02B 6/255

(52) U.S. Cl. CPC G02B 6/2558
USPC 385/99; 156/294

(57) ABSTRACT

A fiber optic splice protecting system includes a tubular sized to fit around spliced ends of optical fibers and a sealant positioned in an annular space defined between the optical fibers and the tubular configured to cure from a liquid to a solid.

### BACKGROUND

Optical fiber is employed for a variety of uses including as a conduit for communication signals and for measuring strain and temperature exhibited therein as well as in structures to which the optical fiber is attached. Optical fibers are spliced together whenever two lengths of fiber need to be functionally connected. Depending upon the environment in which the optical fiber will be employed, it may be desirable to protect the splice. Shrink tubing is commonly employed for this purpose. In such cases the shrink tubing is shrunk to radially compress and thereby attach to the fiber in an area surrounding the splice. While protection provided in this manner is sufficient for some applications, other systems and methods for protecting splices may be better suited for other applications.

### BRIEF DESCRIPTION

Disclosed is a fiber optic splice protecting system which includes a tubular sized to fit around spliced ends of optical fibers and a sealant positioned in an annular space defined between the optical fibers and the tubular configured to cure from a liquid to a solid.

Also disclosed is a method of protecting a fiber optic splice which includes surrounding spliced optical fibers with a tubular, positioning a sealant while uncured in an annular space defined between the optical fibers and the tubular and curing the sealant.

### BRIEF DESCRIPTION OF THE DRAWINGS

The following descriptions should not be considered limiting in any way. With reference to the accompanying drawing, like elements are numbered alike:

FIG. 1 depicts a cross sectional view of a fiber optic splice protecting system disclosed herein.

### DETAILED DESCRIPTION

A detailed description of one or more embodiments of the disclosed apparatus and method are presented herein by way of exemplification and not limitation with reference to the Figures.

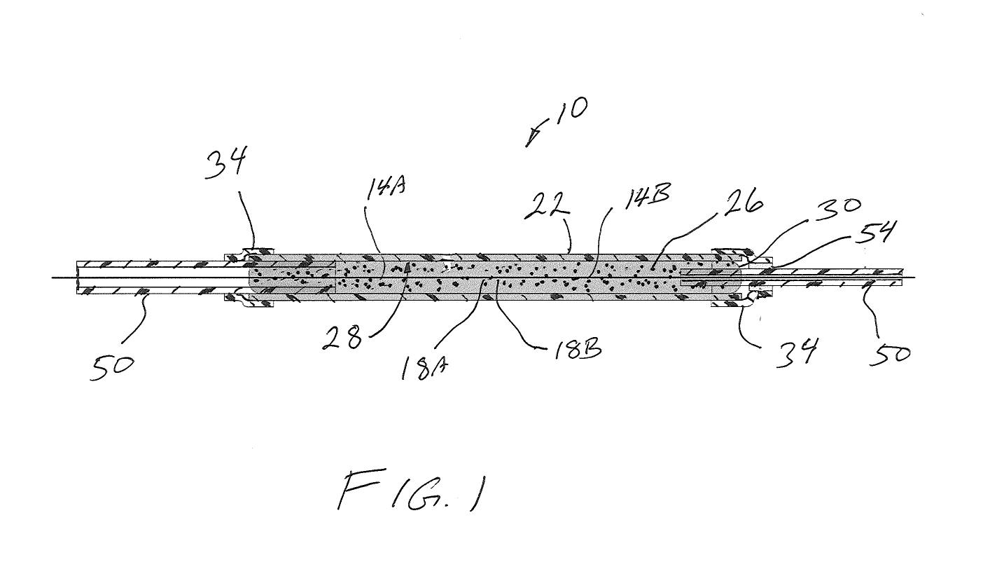

Referring to FIG. 1, an embodiment of a fiber optic splice protecting system disclosed herein is illustrated at 10. The splice protecting system 10 includes a tubular 22 sized to fit over a splice 12, formed by ends 18A and 18B of optical fibers 14A and 14B respectively that have been functionally attached together, while leaving an annular space 26 between an inside surface 28 of the tubular 22 and the fibers 14A and 14B. A sealant 30, flowable when liquid, is positioned in the annular space 26 and maintained there while it cures to a solid.

The optical fibers 14A, 14B are employable in a variety of environments and for a number of uses. For example, the optical fibers 14A, 14B may be used in earth formation boreholes in industries such as carbon dioxide sequestration and hydrocarbon recovery. In these industries the optical fibers can be employed to monitor parameters such as temperature, pressure and strain, for example, at locations thousands of feet into the borehole. The optical fibers 14A, 14B can also provide a conduit for communication via light transmitted therethrough.

Regardless of the particular use of the optical fibers 14A, 14B, such environments can be harsh and therefore protecting the splice 12 is warranted. Protection of the splice 12 in such environments is enhanced by selecting materials for the tubular 22 and the sealant 30 that can withstand high temperatures, pressures and caustic fluids. Embodiments disclosed herein include the tubular 22 being made of polytetrafluoroethylene (PTFE), a polyimide (PI) or other polymer able to withstand high temperatures and caustic environments and the sealant 30 being a high temperature silicone sealants, such as, Dow Corning (Registered Trademark) 736 Oil Resistant Sealant, for example. These materials are resistant to many caustic environments and have excellent high temperature capabilities. Employing these materials for the tubular 22 and the sealant 30 assures that the splice 12 is protected at continuous temperatures as high as 260 degrees Celsius and temporary temperatures as high as 315 degrees Celsius.

The sealant 30 can be injected into the annular space 26 with a syringe with a flexible needle sized to fit within the annular space 26. With care the sealant 30 can be injected without bubbles. During such injection, in this embodiment, the sealant 30 flows around the optical fibers 14A, 14B a full 360 degrees thereby spacing the optical fibers 14A, 14B from the tubular 22 and preventing contact between the optical fibers 14A, 14B and the tubular 22. The viscosity of the sealant 30 can help to hold the ends 18A, 18B of the optical fibers 14A, 14B relative to and fully within the tubular 22 while curing. A chemical bond between the sealant 30 and both the optical fibers 14A, 14B and the tubular 22, once the sealant 30 is cured into a solid, can further maintain the relative position between the splice 12 and the tubular 22. Elasticity of the sealant 30 when solid allows for deflections between the optical fibers 14A, 14B and the tubular 22 without inducing strain in either that could be detrimental thereto.

One or two shrinkable tubes 34 positioned at either or both of ends 38 of the tubular 22 can further aid in maintaining the sealant 30 within the tubular 22 while the sealant 30 is curing as well as reduce movement of the tubular 22 relative to the optical fibers 14A, 14B. By positioning the shrinkable tubes 34 with a first portion 42 positioned around the tubular 22 and a second portion 46 positioned beyond the end 38 when the shrinking of the shrinkable tube 34 is performed causes the first portion 42 to become attached to the tubular 22 while the second portion 46 shrinks to a size smaller than an outer diameter of the tubular 22. This condition essentially forms a cap on the ends 38 to hold the sealant 30 within the tubular 22.

Depending upon sizing of the tubular 22, the shrinkable tube 34, and the optical fibers 14A, 14B, the shrinkable tube 34 could also engage with the optical fibers 14A, 14B directly. However, alternate embodiments of the fiber optic splice protecting system 10 disclosed herein employ one or more optional sleeves 50 that encase the optical fibers 14A, 14B over a significant length thereof The sleeves 50 can extend over a majority of the length of the optical fibers 14A, 14B to provide structural integrity to them when employed in environments wherein they are not otherwise well protected. In embodiment employing the sleeves 50, the sleeves 50 are sized to fit within the annular space 26. This condition has the added benefit that the sleeves 50 can prevent the sealant 30 from escaping from within the annular space 26. Additionally, the second portion 46 of the shrinkable tube 34 can shrink down to engage with the sleeve 50 thereby providing additional positional stability between the tubular 22 and the optical fibers 14A, 14B and the sealant 30 within the annular space 26 prior to curing of the sealant 30. In other embodiments an optional collar 54 is positioned between the second portion 46 and the sleeve 50 so that after the shrinkable tube 34 has been shrunk it is engaged with the outer surface of the collar 50.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A fiber optic splice protecting system comprising:
a tubular sized to fit around spliced ends of optical fibers; and
a sealant positioned in an annular space defined between the optical fibers and the tubular configured to cure from a liquid to a solid.

2. The fiber optic splice protecting systems of claim 1, wherein the tubular is polymeric.

3. The fiber optic splice protecting systems of claim 1, wherein the tubular is resistant to continuous temperatures of at least about 260 degrees Celsius.

4. The fiber optic splice protecting systems of claim 1, wherein the tubular is resistant to temporary temperatures of at least about 315 degrees Celsius.

5. The fiber optic splice protecting systems of claim 1, wherein the tubular is one of polytetrafluoroethylene or a polyimide.

6. The fiber optic splice protecting systems of claim 1, wherein the sealant is resistant to continuous temperatures of at least about 260 degrees Celsius.

7. The fiber optic splice protecting systems of claim 1, wherein the sealant is resistant to temporary temperatures of at least about 315 degrees Celsius.

8. The fiber optic splice protecting systems of claim 1, wherein the sealant is silicone.

9. The fiber optic splice protecting systems of claim 1, further comprising at least one shrinkable tube configured to engage an outer radial surface of the tubular when in a shrunken state.

10. The fiber optic splice protecting systems of claim 9, wherein the at least one shrinkable tube retains the sealant within the tubular while the sealant is curing.

11. The fiber optic splice protecting systems of claim 9, wherein the at least one shrinkable tube positionally retains the tubular relative to the optical fibers while the sealant is curing.

12. The fiber optic splice protecting systems of claim 9, wherein the at least one shrinkable tube is two shrinkable tubes with each of the two shrinkable tubes being positioned near an opposing end of the tubular.

13. The fiber optic splice protecting systems of claim 1, further comprising at least one sleeve partially positionable in the annular space defined between the optical fibers and the tubular.

14. The fiber optic splice protecting systems of claim 13, wherein the at least one sleeve is two sleeves with each of the two sleeves being positioned near an opposing longitudinal end of the tubular.

15. The fiber optic splice protecting systems of claim 13, wherein the at least one sleeve retains the sealant within the tubular while the sealant is curing.

16. The fiber optic splice protecting systems of claim 1, wherein the sealant chemically bonds to at least one of the optical fibers and the tubular.

17. The fiber optic splice protecting systems of claim 1, wherein the sealant is elastic when fully cured.

18. The fiber optic splice protecting systems of claim 1, wherein the sealant fully surrounds the optical fibers.

19. A method of protecting a fiber optic splice comprising:
surrounding spliced optical fibers with a tubular;
positioning a sealant while uncured in an annular space defined between the optical fibers and the tubular; and
curing the sealant.

20. The method of protecting a fiber optic splice of claim 19, further comprising positioning the sealant a full 360 degrees around the optical fibers.

21. The method of protecting a fiber optic splice of claim 19, further comprising preventing bubbles from entering the sealant while positioning the uncured sealant in the annular space.

22. The method of protecting a fiber optic splice of claim 19, further comprising maintaining the sealant in the annular space while the sealant is curing.
